(19) United States
(12) Patent Application Publication
(10) Pub. No.: US 2013/0192320 A1
(43) Pub. Date: Aug. 1, 2013

(54) LOCK SYSTEM

(71) Applicant: CompX International Inc., Greenville, SC (US)

(72) Inventors: Robert E. Dalton, Jr., Greenville, SC (US); Matthew R. Greiner, Greer, SC (US)

(73) Assignee: COMPX INTERNATIONAL INC., Greenville, SC (US)

(21) Appl. No.: 13/647,655

(22) Filed: Oct. 9, 2012

Related U.S. Application Data
(60) Provisional application No. 61/591,082, filed on Jan. 26, 2012.

(51) Int. Cl. E05B 35/10; E05B 19/02; E05B 27/02

(52) U.S. Cl. 70/340; 70/402

(57) ABSTRACT

A lock system is disclosed. The lock system includes a lock and one or more keys. The lock includes a plurality of tumblers configured for interaction with associated key features. A tumbler includes at least two sections and defines at least two contact points. One contact point is configured to interact with a feature included on either of an operator key or a master key, while the other contact point is configured to interact with a feature included on a separate key. A key according to the present disclosure includes features configured to interact with a contact point on each tumbler, such as with only one of the two contact points. One of the keys may include channels defined on surfaces thereof. Such channels accommodate the set of contact points that the features of such key are not interacting with, allowing access to and interaction with the appropriate set of contact points.

### PRIORITY CLAIM

This application claims the benefit of previously filed U.S. Provisional Patent Application entitled “LOCK SYSTEM,” assigned U.S. Ser. No. 61/591,082, filed Jan. 26, 2012, and which is incorporated herein by reference for all purposes.

### FIELD OF THE SUBJECT MATTER

The presently disclosed subject matter relates generally to lock or access control systems, such as may be applied to various enclosures to provide secure storage of various items, equipment, materials, and/or information within the enclosures or cabinets. More specifically, the presently disclosed subject matter relates to tumblers for use in lock systems and associated keys for locking and unlocking such lock systems.

### BACKGROUND OF THE SUBJECT MATTER

Many occasions arise that require or make desirable access control of different cabinets, entryway doors, carts, tool boxes, and/or other types of boxes, hereafter collectively referred to as enclosures (regardless generally of their compositions, materials, or configurations). Such enclosures may be provided with doors and/or may also include drawers or similar access areas or ports.

In general, lock systems used to provide access control to enclosures are known. One exemplary lock system is the so-called pin tumbler lock system. In a pin tumbler lock system, a plug housed within an outer casing rotates to unlock the lock system. Tumblers contained within passages defined in the plug and outer casing align with respect to a shear line, defined at an intersection between the plug and outer casing, to allow the plug to rotate.

Keys associated with pin tumbler lock systems are designed to move the tumblers into alignment with the shear line, allowing the plug to rotate. Many known keys utilize bittings cut into the blade of the key. The bittings typically have, for example, different heights that match different lengths of the tumblers. When the blade of the key is fully inserted into the plug, the bittings may interact with the tumblers to move the tumblers into alignment with the shear line.

Improvements in keys associated with pin tumbler lock systems have further led to the development of so-called dimple keys. Dimple keys have one or more dimples defined in the blade of the key. The dimples interact with the tumblers similarly to bittings to move the tumblers into alignment with the shear line. Dimple keys and associated pin tumbler locks provide improved key strength, smooth key insertion, increased numbers of combinations for unlocking of the lock systems, and key reversibility.

Examples of lock systems are disclosed in, for example, U.S. Pat. No. 5,101,648 to Kuster (disclosing a lock cylinder and key with associated security element) and U.S. Pat. No. 5,615,565 to Field (disclosing keys for cylinder locks). The subject matter of each of the herein-referenced published patent-related documents is fully incorporated herein by reference, for all purposes.

One issue that is of increased concern in the lock system industry, and particularly with regard to pin tumbler lock systems, is the master key capabilities of lock systems. For example, many presently known pin tumbler lock systems require the inclusion of wafers into the design in order to unlock a lock with a master key, which construction technique is a complicated and time consuming process. Further, the requirement of a master key in some lock systems can reduce the number of available combinations for the operator keys otherwise utilized with the locks.

Accordingly, an improved lock system would be desired in the art. In particular, an improved pin tumbler lock system, including improvements to the lock and associated key, would be desired. For example, improvements to the tumblers, and corresponding improvements to the associated operator keys and master keys, would be advantageous.

### SUMMARY OF THE SUBJECT MATTER

Aspects and advantages of the presently disclosed subject matter will be set forth in part in the following description, or may be apparent from the description, or may be learned through practice of the presently disclosed subject matter.

In view of the recognized features encountered in the prior art and addressed by the presently disclosed subject matter, improved apparatus and methodology are presently disclosed for lock systems, and in particular pin tumbler lock systems.

It is a general object of the present disclosure to provide a lock system. A lock system according to the present disclosure advantageously allows for the use of associated master keys without the need for wafers, thus reducing the time and complexity associated with practice of a master key while otherwise providing numerous additional advantages.

A present exemplary lock system may include a lock and one or more keys. Each key may be either of an operator key or a master key. The lock includes a plurality of tumblers configured for interaction with associated key features. When a correct key is utilized, the tumblers will align with shear lines defined in the lock, allowing the lock to move between a locked position and an unlocked position.

One exemplary tumbler according to the present disclosure may include at least two sections, and thus may define two contact points. One contact point may be configured to interact with a feature included on an operator key or a master key, while the other contact point may be configured to interact with a feature included on a separate operator key or master key. The use of tumblers having multiple contact points thus allows for efficient and effective use of the lock with both operator keys and master keys, and without the need for additional apparatus.

An associated key according to the present disclosure includes features configured to interact with a contact point on each tumbler, such as with only one of the two contact points. For example, an operator key may have features configured to interact with one set of contact points on the associated tumblers, while a master key may have features configured to interact with another set of contact points on the associated tumblers. The features may be various contact points on the respective operator key and master key. Further, one of the keys may include channels defined on surfaces thereof. Such channels may accommodate the set of contact points that the features of this key are not interacting with, thus allowing access to and interaction with the appropriate set of contact points.

Yet another presently disclosed exemplary embodiment relates to a lock system, comprising a lock, a first key and a second key. Such lock preferably comprises a casing and a plug housed in such casing, with such casing and such plug defining a tumbler passage extending therethrough, such lock further comprising a tumbler, a driver, and a spring each disposed in such tumbler passage, such tumbler comprising a tumbler first section having a first diameter and a tumbler first contact point and a tumbler second section having a second diameter and a tumbler second contact point. Such first key preferably has a key first contact point configured to contact such tumbler first contact point, for causing such tumbler to move within such tumbler passage such that such plug is rotatable within such casing; and such second key preferably has a key second contact point configured to contact such tumbler second contact point, for causing such tumbler to move within such tumbler passage such that such plug is rotatable within such casing.

In alternative such lock systems, such first and second keys may be configured such that either of contact by such key first contact point with such tumbler first contact point or contact by such key second contact point with such tumbler second contact point causes such tumbler to move within such tumbler passage such that such driver is fully disposed in such casing and such tumbler is fully disposed in such plug.

In other presently disclosed alternatives, such tumbler may further comprise a third section having a third diameter. In others thereof, such tumbler first section may be generally spherical and such tumbler second section may be generally cylindrical. In yet others thereof, a ledge may be defined on such tumbler between such first and second sections thereof; and such tumbler second contact point may be defined on such ledge.

In variations of such exemplary embodiments of such lock system, each of such first and second keys respectively may include a pathway having a curvilinear cross-sectional profile defined in an outer surface thereof; and with such key first contact point residing in such first key pathway, and with such key second contact point residing in such second key pathway. Further, in some variations, such key first contact point may be defined on a valley apex of such first key pathway; and such key second contact point may be defined on a valley apex of such second key pathway.

In other present variations, a channel may be defined in such second key, and configured to accommodate such tumbler first section therein. In others, such casing and such plug may define a plurality of tumbler passages extending therethrough. In some, such plurality of tumbler passages may be arranged in a plurality of rows.

For some variations, such first key may comprise an operator key and such second key may comprise a master key, or vice versa. Also, for some variations, such lock may comprise a cylinder lock.

Yet another presently disclosed exemplary embodiment relates to a tumbler for a lock, such tumbler preferably comprising a first section having a first diameter and a first contact point; a second section having a second diameter greater than such first diameter, and having a second contact point; and a ledge defined between such first section and such second section such that such second contact point is defined on such ledge.

Some such tumbler embodiments may further comprise a third section having a third diameter greater than such second diameter. In others, such first section may be generally spherical; and such second section may be generally cylindrical. In still others, such first section may include a generally spherical portion and a generally cylindrical portion, while such second section may be generally cylindrical. In yet other variations thereof, such first contact point may be defined on a peak of such first section.

Still further presently disclosed exemplary embodiments relates to a key for use in a lock comprising a tumbler, the tumbler comprising a first section and a second section, the first section having a first diameter and a first contact point, the second section having a second diameter greater than the first diameter and a second contact point. For such embodiments, the key preferably comprises a bow; a blade associated with such bow, such blade comprising a first surface and a pathway defined in such first surface, such pathway comprising a plurality of contact points, one of such plurality of contact points configured to contact the second contact point of the tumbler; and a channel defined in such first surface and extending through such pathway, such channel configured to accommodate the first section of the tumbler therein.

In some variations thereof, such pathway may have a curvilinear cross-sectional profile. In others thereof, such pathway may define a plurality of peaks and a plurality of valleys; and each of such plurality of contact points may be respectively defined on an apex of one of such plurality of valleys. For still others, such channel may split such pathway into two pathway portions.

It should also be understood that the presently disclosed subject matter equally encompasses apparatus as well as corresponding and/or associated methodology, and equally relates to lock systems, and lock and key combinations, as well as either or both of master and operator keys provided for use with particular lock arrangements, and vice versa. All such aspects of the presently disclosed subject matter are intended to come within the scope of the present disclosure.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents including combinations of features, parts, or steps or configurations thereof not expressly shown in the figures or stated in the detailed description of such figures. Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification. The accompanying drawings, which are incorporated in and constitute a part of this specification, illustrate embodiments of the presently disclosed subject matter and, together with the description, serve to explain the principles of the presently disclosed subject matter.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIG. 1 is a perspective view of a lock system in accordance with one exemplary embodiment of the present disclosure;

FIG. 2 is an exploded perspective view of the exemplary embodiment lock system of FIG. 1;

FIG. 3 is a cross-sectional view of the exemplary lock system of FIG. 1;

FIG. 4 is a front view of an exemplary tumbler for use in a lock system in accordance with one exemplary embodiment of the present disclosure;

FIG. 5 is a front view of an exemplary tumbler for use in a lock system in accordance with another embodiment of the present disclosure;

FIG. 6A is a perspective view of an exemplary operator key for use in a lock system in accordance with one embodiment of the present disclosure;

FIG. 6B is an enlarged perspective view, as indicated in FIG. 6A, of an exemplary blade of an operator key for use in a lock system in accordance with one embodiment of the present disclosure;

FIG. 7 is an enlarged perspective view of an exemplary blade of an operator key for use in a lock system in accordance with another embodiment of the present disclosure;

FIG. 8A is a perspective view of an exemplary master key for use in a lock system in accordance with one embodiment of the present disclosure; and

FIG. 8B is an enlarged perspective view, as indicated in FIG. 8A, of an exemplary blade of a master key for use in a lock system in accordance with one embodiment of the present disclosure.

### DETAILED DESCRIPTION OF THE PREFERRED EMBODIMENTS

Reference is herein made in detail to exemplary embodiments of the presently disclosed subject matter, one or more examples of which are illustrated in or represented by the drawings. Each example is provided by way of explanation of the presently disclosed subject matter, not limitation of the presently disclosed subject matter. In fact, it will be apparent to those skilled in the art that various modifications and variations can be made in and to the presently disclosed subject matter without departing from the scope or spirit of the presently disclosed subject matter. For instance, features illustrated or described as part of one embodiment may be used with another embodiment to yield a still further embodiment. Thus, it is intended that the presently disclosed subject matter covers such modifications and variations as come within the scope of the disclosure and equivalents thereof.

The present disclosure is directed in general to lock systems, and more particularly to pin tumbler lock systems. A lock system according to the present disclosure includes improved tumblers for use in locks of the lock systems, and further includes improved operator and master keys for use with these locks. The tumblers include multiple tumbler contact points for various keys. For example, a tumbler first contact point (or set of tumbler first contact points on respective plural tumblers) could be associated with an operator key, while a tumbler second contact point (or set of tumbler second contact points on respective plural tumblers) could be associated with a master key. The associated operator key may be designed to interact with the tumbler first contact point but not the second, and the associated master key may be designed to interact with the tumbler second contact point but not the first (or vice versa as to designations). Such interactions between the keys and various tumbler contact points may align the tumblers with the shear line of the lock, facilitating unlocking as discussed below.

The presently disclosed lock systems provide a number of significant advantages. In particular, lock systems according to the present disclosure allow for the use of associated master keys without the need for wafers, thus reducing the time and complexity associated with use of a master key. Additionally, the present tumblers and associated keys allow for increased numbers of combinations, for use in both operator keys and master keys. Further, both operator keys and master keys according to the present disclosure may be inserted into and removed from locks in both locked and unlocked positions, and in some presently disclosed embodiments, in respective reversed positions thereof.

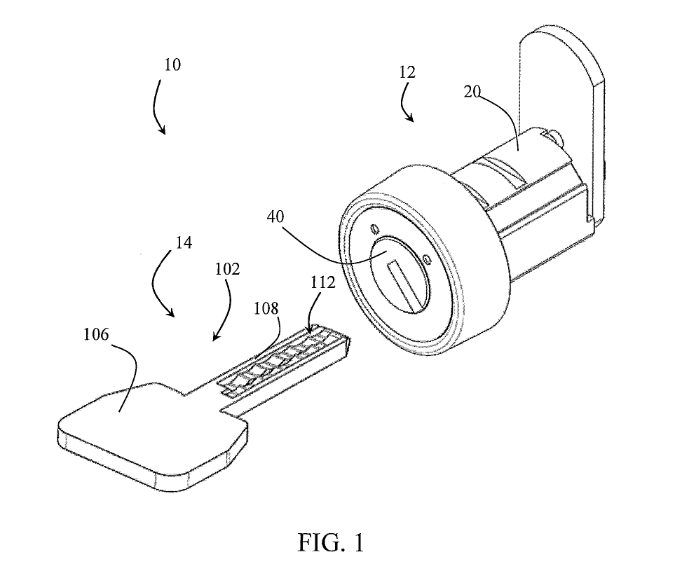

An exemplary lock system generally 10 is shown in FIGS. 1 through 3. The lock system 10 generally includes a lock 12 and a key 14. As shown, the lock system 10 is a pin tumbler lock system. Further, while in exemplary embodiments the lock system 10 is additionally a cylinder lock system, as shown, in other embodiments the lock system 10 may be a radial lock system or other suitable lock system that utilizes pin tumbler features. Still further, while in exemplary embodiments the lock system 10 may be additionally a cam lock system, in other embodiments the lock system 10 may be any suitable lock system with any suitable locking features or apparatus. The presently illustrated lock system is intended as representative of all such variations.

A lock 12 according to the present disclosure includes a casing 20. In exemplary embodiments, the casing 20 may be generally cylindrical. Alternatively, however, the casing 20 may be cubic or have any other suitable three-dimensional shape. A bore hole 22 may be defined in the casing 20. The bore hole 22 may be generally cylindrical, or have any other suitable three-dimensional shape. The bore hole 22 may, for example, extend from a front face 24 of the casing 20 at least partially through the casing 20. The bore hole 22 may extend along a central longitudinal axis 26 defined by the casing 20, or may extend at any suitable angle and/or be offset from such representative axis 26.

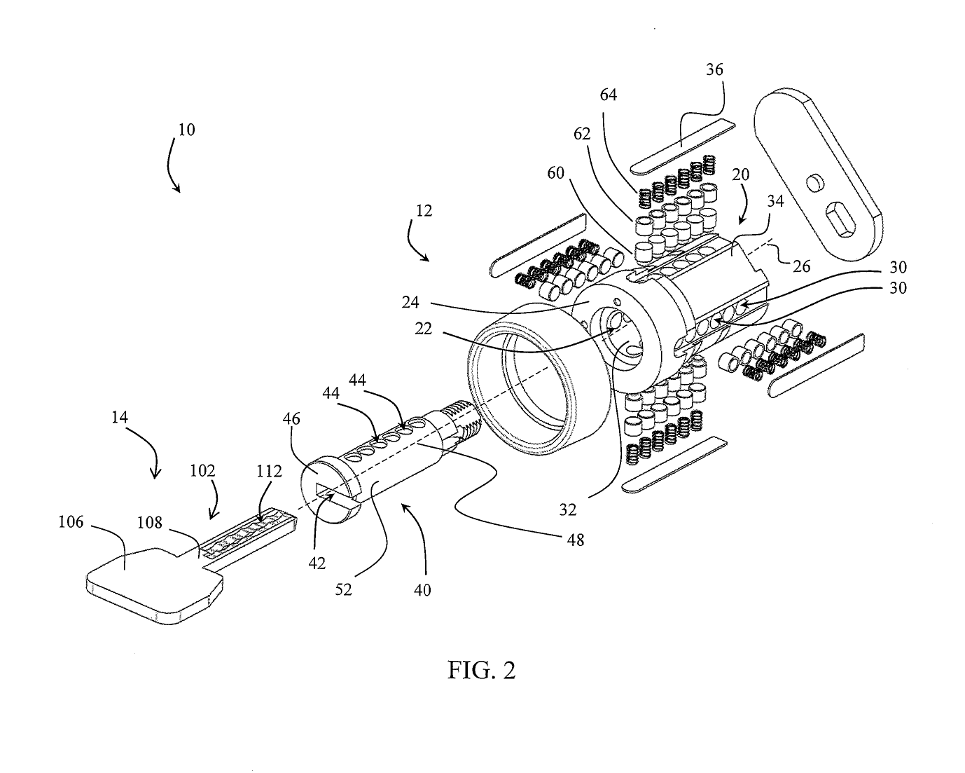

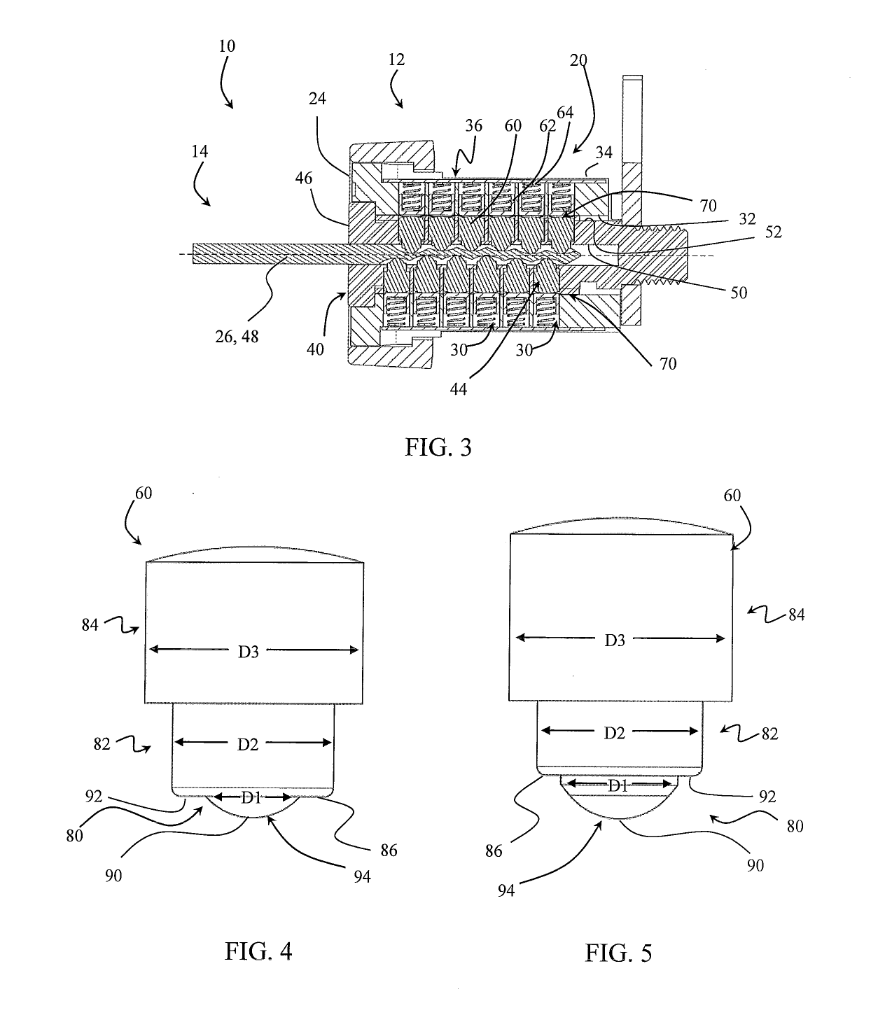

Casing 20 further includes one or more tumbler bore holes 30 defined therein, as shown in FIGS. 2 and 3. Each tumbler bore hole 30 extends through a portion of the casing 20 to the bore hole 22, through an inner body surface 32 of the casing 20 that defines the bore hole 22. In some embodiments, a tumbler bore hole 30 further extends through an outer body surface 34 of the casing 20. A cover 36 may cover the tumbler bore hole 30 from the outer body surface 34, as shown. The tumbler bore holes 30 may, in exemplary embodiments, extend through the casing 20 generally perpendicularly to the central longitudinal axis 26. Alternatively, the tumbler bore holes 30 may extend at any suitable angle to the central longitudinal axis 26. As shown, the tumbler bore holes 30 may have any suitable arrangement about the casing 20 and with respect to the central longitudinal axis 26. For example, one or more rows of tumbler bore holes 30 may be defined. Each row may include one or more tumbler bore holes 30 extending along the central longitudinal axis 26, as shown, or at an angle thereto. The various rows of tumbler bore holes 30 may be spaced apart about the central longitudinal axis 26. For example, FIGS. 2 and 3 illustrate four rows of tumbler bore holes 30 equally spaced apart about the central longitudinal axis 26. It should be understood that any number of rows of tumbler bore holes 30, such as one, two, three, four or more, having any number of tumbler bore holes 30 per row is within the scope and spirit of the present disclosure.

Lock 12 may further include a plug 40. The bore hole 22 of the casing 20 may be sized and shaped to accommodate the plug 40 therein. A representative plug 40 according to the present disclosure is typically cylindrical, and is thus typically housed in a cylindrical bore hole 22, facilitating rotation of the plug 40 within the bore hole 22, such as about the central longitudinal axis. It should be understood, however, that the present disclosure is not limited to cylindrical plugs 40, and rather that plugs 40 having any suitable shape are within the scope and spirit of the present disclosure.

Plug 40 further includes a keyway 42 and one or more tumbler bore holes 44 defined therein, as shown in FIGS. 2 and 3. The keyway 42 may, for example, extend from a front face 46 of the plug 40 at least partially through the plug 40. The keyway 42 may extend along a central longitudinal axis 48 defined by the plug 40, or may extend at any suitable angle and/or be offset from this axis 48. Notably, when the plug 40 is situated within the casing 20, the longitudinal axes 26 and 48 may align.

Each tumbler bore hole 44 extends through a portion of the plug 40 to the keyway 42, through an inner body surface 50 of the plug 40 that defines the keyway 42. The tumbler bore holes 44 further extend through an outer body surface 52 of the plug 40. The tumbler bore holes 44 may, in exemplary embodiments, extend through the plug 40 generally perpendicularly to the central longitudinal axis 48. Alternatively, the tumbler bore holes 44 may extend at any suitable angle to the central longitudinal axis 48. As shown, the tumbler bore holes 44 may have any suitable arrangement about the plug 40 and with respect to the central longitudinal axis 48. For example, one or more rows of tumbler bore holes 44 may be defined. Each row may include one or more tumbler bore holes 44 extending along the central longitudinal axis 48, as shown, or at an angle thereto. The various rows of tumbler bore holes 44 may be spaced apart about the central longitudinal axis 48. For example, FIGS. 2 and 3 illustrate four rows of tumbler bore holes 44 equally spaced apart about the central longitudinal axis 48. It should be understood that any number of rows of tumbler bore holes 44, such as one, two, three, four or more, having any number of tumbler bore holes 44 per row is within the scope and spirit of the present disclosure.

In exemplary embodiments, at least a portion of the tumbler bore holes 44 of the plug 40 may align with the tumbler bore holes 30 of the casing 20 when the lock 12 is in a locked position, as shown. A respective aligned tumbler bore hole 30 and tumbler bore hole 44 are collectively referred to herein as a tumbler passage. For example, as shown in FIG. 3, at least two rows of tumbler bore holes 44 may align with a respective two rows of tumbler bore holes 30 when the lock 12 is in a locked position, thus defining two rows of tumbler passages. This allows tumblers disposed in the tumbler bore holes 44 and 30 to extend into and move between both a respective tumbler bore holes 44 and tumbler bore hole 30, as discussed below. Any number of tumbler bore holes 44 or rows of tumbler bore holes 44 may align with any respective number of tumbler bore holes 30 or rows of tumbler bore holes 30 when the lock 12 is in a locked position. For example, one, two, three, four or more rows of tumbler bore holes 44 may align with the respective rows of tumbler bore holes 30 when the lock 12 is in a locked position. Further, a row of tumbler bore holes 44 may align with more than one row of tumbler bore holes 30, as shown in FIG. 2.

As shown in FIGS. 2 through 5, a tumbler 60, a driver 62, and a spring 64 may each be disposed within one or more tumbler passages. For example, a tumbler 60, driver 62, and spring 64 may be included in each tumbler passage in a row of tumbler passages, as shown in FIGS. 2 and 3, or various of such tumbler passages may be left empty. Further, various tumbler bore holes 30 that are not aligned with tumbler bore holes 44 to define tumbler passages may include a driver 62 and a spring 64 therein. If the lock 12 is rotated such that these formerly non-aligned tumbler bore holes 30 become aligned with tumbler bore holes 44 to define tumbler passages, then tumblers 60 disposed in the tumbler bore holes 44 may interact with these drivers 62 and springs 64 to allow the lock 12 to operate between locked and unlocked positions.

As shown in FIGS. 2 and 3, a tumbler 60 is disposed in a tumbler passage such that the tumbler 60 can interact with a key 14 inserted into the keyway 42. A driver 62 is disposed in the tumbler passage in contact with the tumbler 60, and a spring 64 is disposed in the tumbler passage in contact with the driver 62. The spring 64 provides a biasing force against the driver 62, which transmits this force to the tumbler 60, biasing the tumbler 60 towards the keyway 42.

As is generally understood in the art, alignment of the tumblers 60 and drivers 62 along shear lines 70 defined in the lock 12 allow the lock 12 to be rotated between a locked position and an unlocked position. A shear line 70 is defined at the intersection between the casing 20 and the plug 40. When the lock 12 is in the locked position, without a key 14 inserted in the keyway 42, the tumblers 60 and/or the drivers 62 may generally be disposed in both the tumbler bore holes 30 and tumbler bore holes 44 of the respective tumbler passages. The tumblers 60 and/or drivers 62 thus intersect with the shear lines 70, blocking rotation of the plug 40 in the casing 20 and placing the lock 12 in the locked position. When a key 14 is inserted into the keyway 42, the tumblers 60 and drivers 62 are moved within their respective tumbler passages. Use of a correct key 14 that will unlock the lock 12 causes alignment of the tumblers 60 and drivers 62 along the shear lines 70, such that the tumblers 60 are fully disposed in the tumbler bore holes 44 and the drivers 62 are fully disposed in the tumbler bore holes 30. The tumblers 60 and drivers 62 thus no longer intersect with the shear lines 70, allowing rotation of the plug 40 in the casing 20 to place the lock 12 in an unlocked position.

Exemplary tumblers 60 are shown in FIGS. 2 through 5. A tumbler 60 according to the present disclosure generally includes multiple sections, each of which may have a separate maximum diameter or width (collectively referred to herein as “diameter”). In general, a tumbler 60 according to the present disclosure includes at least two sections. As shown in FIGS. 2 through 5, for example, exemplary tumblers 60 include a tumbler first section 80 having a first diameter D1 and a tumbler second section 82 having a second diameter D2. In exemplary embodiments as shown, the first diameter D1 is less than the second diameter D2. In some embodiments, as further shown in FIGS. 2 through 5, a tumbler 60 further includes a tumbler third section 84 having a third diameter D3. The second diameter D2 may be less than the third diameter D3.

It should be understood that each section of the tumbler 60 may have any suitable shape and size. For example, a section may in some embodiments be generally cylindrical, as shown by the second and third sections 82 and 84 in FIGS. 4 and 5. Further, a section may in some embodiments be generally spherical, as shown by the first section 86 in FIG. 4. Still further, a section may in some embodiments include a cylindrical portion and a spherical portion, as shown in FIG. 5. In other embodiments, however, a section may be generally cubic, or may have any other suitable shape. In general, the section having the largest diameter may have a shape and size that corresponds to the shape and size of the associated tumbler passage that the tumbler 60 is disposed in, thus allowing the tumbler 60 to move within the tumbler passage.

As shown, a ledge 86 may be defined on a tumbler 60 at an intersection between two sections of the tumbler 60, such as between the first section 80 and second section 82. As discussed below, the ledge 86 provides an additional contact point on the tumbler 60 wherein a key 14 can contact the tumbler 60 to move it within the tumbler passage.

A tumbler 60 according to the present disclosure includes multiple contact points. Each contact point on a tumbler 60 may be configured for use with a specific key 14 to align the tumbler 60 with the shear line 70, as discussed above. For example, one contact point may be configured for use with an operator key or master key, while another contact point is configured for use with a separate operator key or a master key. As shown in FIGS. 4 and 5, for example, an exemplary tumbler 60 includes a tumbler first contact point 90 and a tumbler second contact point 92. The first contact point 90 may be defined on a peak 94, such as on an apex of the peak 94 as shown, or on another suitable point of contact on the first section 80 of the tumbler 60. The second contact point 92 may be defined on the ledge 86 between the first section 80 and second section 82. In exemplary embodiments, the first contact point 90 of the tumbler 60 may be associated with an operator key for the lock 12. Thus, when an associated operator key is inserted in the keyway 42, as discussed below, the key may interact with the first contact point 90 to move the tumbler 60 into alignment with the shear line 70. It should be understood that in other embodiments the first contact point 90 may be associated with a master key. In further exemplary embodiments, the second contact point 92 of the tumbler 60 may be associated with a master key for the lock 12. Thus, when an associated master key is inserted in the keyway 42, as discussed below, the key may interact with the second contact point 92 to move the tumbler 60 into alignment with the shear line 70. It should be understood that in other embodiments the second contact point 92 may be associated with an operator key.

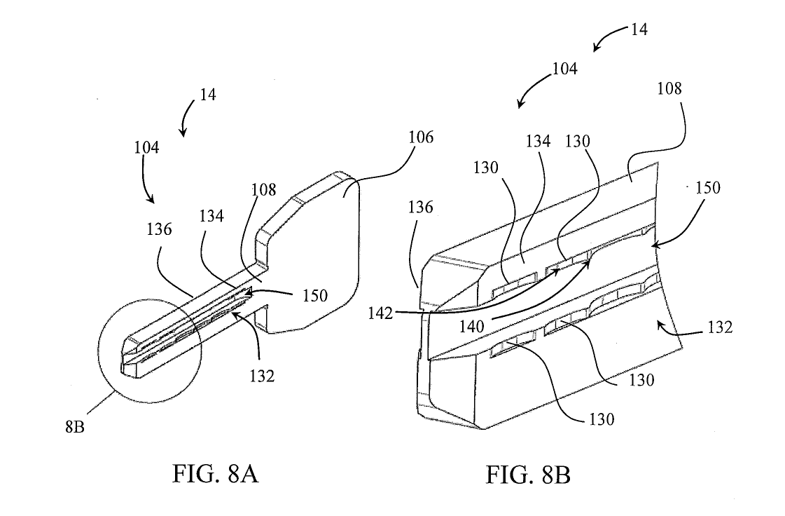

A key 14 for use with a lock 12 in a lock system 10 of the present disclosure includes features configured to interact with contact points on various tumblers 60 to align the tumblers 60 with the shear lines 70. Exemplary operator keys 102 are shown in FIGS. 1 through 3 and 6 through 7, while an exemplary master key 104 is shown in FIGS. 8A and 8B. In exemplary embodiments, the operator key 102 includes features configured to interact with the first contact points 90 of the tumblers 60, while the master key 104 includes features configured to interact with the second contact points 92 of the tumblers 60. Alternatively, however, the operator key 102 features may interact with the second contact points 92 while the master key 104 features may interact with the first contact points 90, or the features of the operator key 102 and master key 104 may be configured to interact with various first and second contact points 90, 92.

A key 14, such as an operator key 102 or a master key 104, generally includes a bow 106 and a blade 108. The blade 108 is inserted into the keyway 42 to interact with the various tumblers 60 of the lock 12. The blade 108 of a correct key 14 that will allow the lock 12 to be rotated to an unlocked position includes features that contact and interact with the tumblers 60 to move the tumblers 60 into alignment with the shear lines 70. The bow 106 of the key 14 is not inserted into the keyway 42, but rather is left protruding from the lock 12. A user may grasp the bow 106 to rotate the key 14 between the locked and unlocked positions.

As discussed, a key 14 according to the present disclosure includes features configured to contact and interact with the contact points defined on the tumblers 60. For example, an operator key 102 may include features configured to contact and interact with various contact points, such as the first contact points 90 or second contact points 92, on the tumblers 60. As shown in FIGS. 1 through 3 and 6 through 7, an operator key 102 may include a plurality of key first contact points 110. Each key contact point 110 may contact and interact with an associated tumbler contact point 90 when the operator key 102 is inserted into the keyway 42. This contact and interaction may move the tumblers 60 within the tumbler passages such that they are aligned with the shear lines 70.

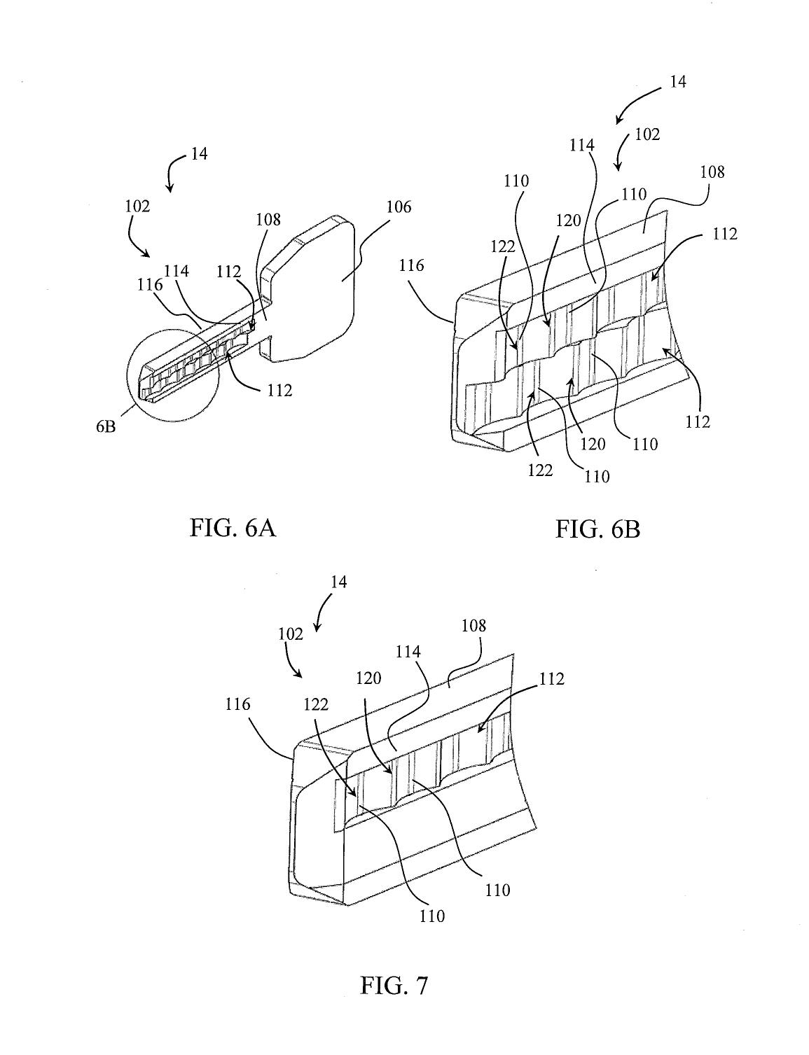

A suitable pattern may be defined on one or more surfaces of the blade 108 of the operator key 102. This pattern thus defines a pathway 112 which is defined in the blade 108 and includes the key first contact points 110. The pathway 112 may be defined in any suitable surface of the blade 108 to interact with various associated tumblers 60. For example, a pathway 112 may be defined in a first surface 114 and/or an opposing second surface 116 of the operator key 102, as shown in FIG. 3. These pathways 112 may interact with opposing rows of tumblers 60 to lock and unlock the lock 12. An operator key 102 with a single pathway 112 defined on each surface 114, 116 is shown in FIG. 7. Further, in some embodiments as shown in FIGS. 6A and 6B, more than one pathway 112 may be defined on each surface 114, 116. For example, two pathways 112 may be defined on each surface 114, 116. The inclusion of two pathways 112 on each surface 114, 116 may in exemplary embodiments allow the key 102 to be reversible. For example, one pathway 112 on each surface 114, 116 may interact with the tumblers 60 when the blade 108 is placed in the keyway 42 in one position, and the other pathway 112 on each surface 114, 116 may interact with the tumblers 60 when the blade 108 is placed in the keyway 42 in a reversed position. Stated another way, reversible in this context means that the key will operate the lock when inserted in either 180 degree rotation about the centerline axis of the key blade.

A pathway 112 according to the present disclosure may in exemplary embodiments have a curvilinear cross-sectional profile, as shown in FIGS. 1 through 3 and 6 through 7. The curvilinear cross-sectional profile is in exemplary embodiments continuous throughout the cross-sectional profile of the pathway 112. Further, in some exemplary embodiments, the pathway 112 may have a generally waveform cross-sectional profile. A plurality of peaks 120 and a plurality of valleys 122 may be defined by the pathway 112, whether the pathway 112 is curvilinear or otherwise. In embodiments wherein the pathway 112 is continuously curvilinear, both the peaks 120 and valleys 122 may thus be generally curvilinear, as shown. In exemplary embodiments, the first contact points 110 are defined on the valleys 122, such as on apexes of the valleys 122 defined in the pathway 112 as shown. For example, in some exemplary embodiments as shown in FIGS. 1 through 3 and 6 through 7, the first contact points 110 are on the valleys 122 of a pathway 112 having a continuous waveform cross-sectional profile. Thus, when the blade 108 is properly inserted into the lock 12, the tumbler first contact points 90 are each in contact with and interacting with the associated key first contact points 110 to move the tumblers 60 into alignment with the shear lines 70.

A master key 104 may similarly include features configured to contact and interact with various contact points, such as the tumbler second contact points 92, on the tumblers 60. As shown in FIGS. 8A and 8B, a master key 104 may include a plurality of key second contact points 130. Each key second contact point 130 may contact and interact with an associated tumbler second contact point 92 when the master key 104 is inserted into the keyway 42. This contact and interaction may move the tumblers 60 within the tumbler passages such that they are aligned with the shear lines 70.

A suitable pattern may be defined on one or more surfaces of the blade 108 of the master key 104. This pattern thus defines a pathway 132 which is defined in the blade 108 and includes the key second contact points 130. The pathway 132 may be defined in any suitable surface of the blade 108 to interact with various associated tumblers 60. For example, a pathway 132 may be defined in a first surface 134 and/or an opposing second surface 136 of the master key 104. These pathways 132 may interact with opposing rows of tumblers 60 to lock and unlock the lock 12. A master key 104 with a single pathway 132 defined on each surface 134, 136 is shown in FIGS. 8A and 8B. Further, in some embodiments, more than one pathway 132 may be defined on each surface 134, 136. For example, two pathways 132 may be defined on each surface 134, 136, allowing the key 104 to be reversible as discussed above.

A pathway 132 according to the present disclosure may in exemplary embodiments have a curvilinear cross-sectional profile, as shown in FIGS. 8A and 8B. The curvilinear cross-sectional profile is in exemplary embodiments continuous throughout the cross-sectional profile of the pathway 132. Further, in some exemplary embodiments, the pathway 132 may have a generally waveform cross-sectional profile. A plurality of peaks 140 and a plurality of valleys 142 may be defined by the pathway 132, whether the pathway 132 is curvilinear or otherwise. In embodiments wherein the pathway 132 is continuously curvilinear, both the peaks 140 and valleys 142 may thus be generally curvilinear, as shown. In exemplary embodiments, the key second contact points 130 are defined on the valleys 142, such as on apexes of the valleys 142 defined in the pathway 132 as shown. For example, in some exemplary embodiments as shown in FIGS. 8A and 8B, the second contact points 130 are on the valleys 142 of a pathway 132 having a continuous waveform cross-sectional profile.

Further, as shown in FIGS. 8A and 8B with respect to the master key 104, the blade 108 of a key 14 having features configured to interact with the second contact points 92 of the tumblers 60 may include one or more channels 150 defined therein. The channels 150 may accommodate portions of the tumblers 60, such as portions of the first section 80 including the first contact point 90, therein. The channels 150 thus allow a key 14 to be inserted into a keyway 42 without any portion of the blade 108 interacting with the first contact points 90 of the tumblers 60. For example, FIGS. 8A and 8B illustrate a channel 150 defined in a first surface 134 of a master key 104. An opposing channel 150 may similarly be defined in the second surface 136 of the master key 104. As shown, the channel 150 extends through the pathway 132 defined in the first surface 134, splitting the pathway 132 into two pathway portions. As discussed, this allows the first contact points 90 to be accommodated within the channels 150 such that no interaction occurs therewith, while the second contact points 92 contact and interact with the second contact points 130. Thus, when the blade 108 is properly inserted into the lock 12, the second contact points 92 are each in contact with and interacting with the associated second contact points 130 to move the tumblers 60 into alignment with the shear lines 70.

The present written description uses examples to disclose the presently disclosed subject matter, including the best mode, and also to enable any person skilled in the art to practice the presently disclosed subject matter, including making and using any devices or systems and performing any incorporated and/or associated methods. While the presently disclosed subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the presently disclosed subject matter as would be readily apparent to one of ordinary skill in the art.

What is claimed is:

1. A lock system, comprising:
a lock comprising a casing and a plug housed in said casing, with said casing and said plug defining a tumbler passage extending therethrough, said lock further comprising a tumbler, a driver, and a spring each disposed in said tumbler passage, said tumbler comprising a tumbler first section having a first diameter and a tumbler first contact point and a tumbler second section having a second diameter and a tumbler second contact point;
a first key having a key first contact point configured to contact said tumbler first contact point, for causing said tumbler to move within said tumbler passage such that said plug is rotatable within said casing; and
a second key having a key second contact point configured to contact said tumbler second contact point, for causing said tumbler to move within said tumbler passage such that said plug is rotatable within said casing.

2. The lock system of claim 1, wherein said first and second keys are configured such that either of contact by said key first contact point with said tumbler first contact point or contact by said key second contact point with said tumbler second contact point causes said tumbler to move within said tumbler passage such that said driver is fully disposed in said casing and said tumbler is fully disposed in said plug.

3. The lock system of claim 1, wherein said tumbler further comprises a third section having a third diameter.

4. The lock system of claim 1, wherein said tumbler first section is generally spherical and said tumbler second section is generally cylindrical.

5. The lock system of claim 1, wherein:
a ledge is defined on said tumbler between said first and second sections thereof; and
said tumbler second contact point is defined on said ledge.

6. The lock system of claim 1, wherein:
each of said first and second keys respectively includes a pathway having a curvilinear cross-sectional profile defined in an outer surface thereof; and
said key first contact point resides in said first key pathway, and said key second contact point resides in said second key pathway.

7. The lock system of claim 6, wherein:
said key first contact point is defined on a valley apex of said first key pathway; and
said key second contact point is defined on a valley apex of said second key pathway.

8. The lock system of claim 1, wherein a channel is defined in said second key, and configured to accommodate said tumbler first section therein.

9. The lock system of claim 1, wherein said casing and said plug define a plurality of tumbler passages extending therethrough.

10. The lock system of claim 9, wherein said plurality of tumbler passages are arranged in a plurality of rows.

11. The lock system of claim 1, wherein said first key comprises an operator key and said second key comprises a master key.

12. The lock system of claim 1, wherein said first key comprises a master key and said second key comprises an operator key.

13. The lock system of claim 1, wherein said lock comprises a cylinder lock.

14. A tumbler for a lock, said tumbler comprising:
a first section having a first diameter and a first contact point;
a second section having a second diameter greater than said first diameter, and having a second contact point; and
a ledge defined between said first section and said second section such that said second contact point is defined on said ledge.

15. The tumbler of claim 14, further comprising a third section having a third diameter greater than said second diameter.

16. The tumbler of claim 14, wherein:
said first section is generally spherical; and
said second section is generally cylindrical.

17. The tumbler of claim 14, wherein:
said first section includes a generally spherical portion and a generally cylindrical portion; and
said second section is generally cylindrical.

18. The tumbler of claim 14, wherein said first contact point is defined on a peak of said first section.

19. A key for use in a lock comprising a tumbler, the tumbler comprising a first section and a second section, the first section having a first diameter and a first contact point, the second section having a second diameter greater than the first diameter and a second contact point, the key comprising:
a bow;
a blade associated with said bow, said blade comprising a first surface and a pathway defined in said first surface, said pathway comprising a plurality of contact points, one of said plurality of contact points configured to contact the second contact point of the tumbler; and
a channel defined in said first surface and extending through said pathway, said channel configured to accommodate the first section of the tumbler therein.

20. The key of claim 19, wherein said pathway has a curvilinear cross-sectional profile.

21. The key of claim 19, wherein:
said pathway defines a plurality of peaks and a plurality of valleys; and
each of said plurality of contact points is respectively defined on an apex of one of said plurality of valleys.

22. The key of claim 19, wherein said channel splits said pathway into two pathway portions.
